(19) United States
(12) Patent Application Publication
(10) Pub. No.: US 2013/0285566 A1
(43) Pub. Date: Oct. 31, 2013

(54) LIGHT EMITTING DIODE DRIVING APPARATUS

(71) Applicant: Won Young LEE, Suwon (KR)

(72) Inventor: Won Young LEE, Suwon (KR)

(21) Appl. No.: 13/585,428

(22) Filed: Aug. 14, 2012

(30) Foreign Application Priority Data
Apr. 30, 2012 (KR) 10-2012-0045442

(51) Int. Cl. H05B 37/02

(52) U.S. Cl. 315/192

(57) ABSTRACT

There is provided a light emitting diode (LED) driving apparatus capable of simplifying a peripheral circuit and reducing manufacturing costs by driving two LED channels by a single field effect transistor (FET). The light emitting diode driving apparatus includes: a power supplying unit switching input power according to a control and including a transformer transforming the switched power into a preset driving power to supply the driving power; a light emitting diode unit including at least one light emitting diode group including first and second light emitting diode arrays each having at least one light emitting diode, the first and second light emitting diode arrays being connected to an output terminal of the transformer to form a single loop and receiving the driving power to emit light; and a controlling unit controlling power switching of the power supplying unit.

### CROSS-REFERENCE TO RELATED APPLICATIONS

This application claims the priority of Korean Patent Application No. 10-2012-0045442 filed on Apr. 30, 2012, in the Korean Intellectual Property Office, the disclosure of which is incorporated herein by reference.

### BACKGROUND OF THE INVENTION

1. Field of the Invention

The present invention relates to alight emitting diode driving apparatus having a simplified circuit configuration.

2. Description of the Related Art

A cold cathode fluorescent lamp (CCFL) used as a light source of a backlight unit of a liquid crystal display (LCD) generally has disadvantages in that it uses mercury gas which may cause environmental pollution, has a slow response speed and low color reproducibility, and is not appropriate for implementing slimness and lightness in an LCD panel.

Therefore, light emitting diodes (LED) have recently been actively used in display devices. LEDs have advantages in that they are environmentally-friendly, have a response speed on the level of several nano seconds to allow for a high speed response, such that they are effective for displaying a video signal stream, may perform impulsive driving, have high color reproducibility, may arbitrarily change brightness, color temperature, or the like, by controlling light amounts of red, green, and blue LEDs, and are appropriate for slimness and lightness of an LCD panel, as compared to a CCFL.

In a backlight unit using LEDs, an LED driving apparatus supplying a current to the LEDs to thereby drive the LEDs is necessarily used.

In the LED driving apparatus described above, as described in the following Related Art Document, since LED channels are connected in parallel with each other, field effect transistors (FETs), controlling the supply of current, should be used for respective LED channels, such that manufacturing costs increase, and a relatively expensive control integrated circuit (IC) for controlling respective FETs is used, such that manufacturing costs further increase.

### RELATED ART DOCUMENT

Korean Patent Laid-open Publication No. 10-2011-0012503

### SUMMARY OF THE INVENTION

An aspect of the present invention provides a light emitting diode (LED) driving apparatus allowing for a simplified peripheral circuit and reduced manufacturing costs by driving two LED channels by a single field effect transistor (FET).

According to an aspect of the present invention, there is provided a light emitting diode driving apparatus including: a power supplying unit switching input power according to a control and including a transformer transforming the switched power into a preset driving power, to thus supply the driving power; a light emitting diode unit including at least one light emitting diode group including first and second light emitting diode arrays each having at least one light emitting diode, the first and second light emitting diode arrays being connected to an output terminal of the transformer to form a single loop and receiving the driving power to emit light; and a controlling unit controlling power switching of the power supplying unit.

The transformer may include a primary winding receiving the switched power and at least one secondary winding having a preset turns ratio for the primary winding, and the first and second light emitting diode arrays of the at least one light emitting diode group may be electrically connected to one end and the other end of the at least one secondary winding, respectively, to form the single loop.

The power supplying unit may further include a current control switch connected between the first and second light emitting diode arrays to control current flowing in the first and second light emitting diode arrays according to the control of the controlling unit.

The respective first and second light emitting diode arrays may include a plurality of light emitting diodes connected to one another in series.

The one end of the at least one secondary winding of the transformer may have a positive voltage level and the other end thereof may have a negative voltage level, an anode of a first light emitting diode of the plurality of light emitting diodes of the first light emitting diode array may be electrically connected to the one end of the at least one secondary winding, and a cathode of a final light emitting diode of the plurality of light emitting diodes of the second light emitting diode array may be electrically connected to the other end of the at least one secondary winding.

The current control switch may be electrically connected between a cathode of a final light emitting diode of the plurality of light emitting diodes of the first light emitting diode array and an anode of a first light emitting diode of the plurality of light emitting diodes of the second light emitting diode array.

The power supplying unit may further include a power switch switching the input power according to the control of the controlling unit.

The transformer may include a plurality of secondary windings each having one end with a positive voltage level and the other end with a negative voltage level, and the light emitting diode unit may include a plurality of light emitting diode groups each connected to the plurality of secondary windings.

An anode of a first light emitting diode of a plurality of light emitting diodes of each first light emitting diode array of the plurality of light emitting diode groups may be electrically connected to one end of a corresponding secondary winding, and a cathode of a final light emitting diode of a plurality of light emitting diodes of each second light emitting diode array of the plurality of light emitting diode groups may be electrically connected to the other end of the corresponding secondary winding.

The power supplying unit may further include a plurality of current control switches each electrically connected between a cathode of a final light emitting diode of the plurality of light emitting diodes of each first light emitting diode array of the plurality of light emitting diode groups and an anode of a first light emitting diode of the plurality of light emitting diodes of each second light emitting diode array thereof.

The controlling unit may include a plurality of control units each controlling the plurality of current control switches.

According to another aspect of the present invention, there is provided a light emitting diode driving apparatus including: a power supplying unit including a power switch switching input power according to a control, a transformer having a primary winding receiving the switched power and at least one secondary winding having a preset turns ratio for the primary winding, to thus output a preset driving power, and a current control switch controlling current of a light emitting diode to which the driving power is transferred; a light emitting diode unit including at least one light emitting diode group including first and second light emitting diode arrays each having at least one light emitting diode, the first and second light emitting diode arrays being connected to one end and the other end of the secondary winding, respectively, to form a single loop and receiving the driving power to emit light; and a controlling unit controlling power switching and current control switching of the power supplying unit.

The respective first and second light emitting diode arrays may include a plurality of light emitting diodes connected to one another in series, the one end of the at least one secondary winding of the transformer may output driving power having a positive voltage level and the other end thereof may output driving power having a negative voltage level, an anode of a first light emitting diode of the plurality of light emitting diodes of the first light emitting diode array may be electrically connected to the one end of the at least one secondary winding, and a cathode of a final light emitting diode of the plurality of light emitting diodes of the second light emitting diode array may be electrically connected to the other end of the secondary winding.

The current control switch may be electrically connected between a cathode of a final light emitting diode of the plurality of light emitting diodes of the first light emitting diode array and an anode of a first light emitting diode of the plurality of light emitting diodes of the second light emitting diode array.

According to another aspect of the present invention, there is provided a light emitting diode driving apparatus including: a power supplying unit including a power switch switching input power according to a control, a transformer having a primary winding receiving the switched power and a plurality of secondary windings having a preset turns ratio for the primary winding to output a preset driving power, and a plurality of current control switches controlling current of a light emitting diode to which the driving power from respective windings among the plurality of secondary windings is transferred; a light emitting diode unit including a plurality of light emitting diode groups including first and second light emitting diode arrays each having at least one light emitting diode, the first and second light emitting diode arrays being connected to one end and the other end of a corresponding secondary winding, respectively, to form a single loop and receiving the driving power to emit light; and a controlling unit controlling power switching and current control switching of the power supplying unit.

The respective first and second light emitting diode arrays may include a plurality of light emitting diodes connected to one another in series, one end of respective windings among the plurality of secondary windings of the transformer may output driving power having a positive voltage level and the other end thereof may output driving power having a negative voltage level, an anode of a first light emitting diode of the plurality of light emitting diodes of the first light emitting diode array may be electrically connected to one end of the corresponding secondary winding, and a cathode of a final light emitting diode of the plurality of light emitting diodes of the second light emitting diode array may be electrically connected to the other end of the corresponding secondary winding.

Respective current control switches among the plurality of current control switches may be electrically connected between a cathode of a final light emitting diode of the plurality of light emitting diodes of the first light emitting diode array of a corresponding light emitting diode group and an anode of a first light emitting diode of the plurality of light emitting diodes of the second light emitting diode array thereof.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit diagram schematically showing a light emitting diode driving apparatus according to an embodiment of the present invention;

FIG. 2 is a circuit diagram schematically showing a light emitting diode driving apparatus according to another embodiment of the present invention;

FIG. 3 is a circuit diagram schematically showing a current transfer path of the light emitting diode driving apparatus according to the embodiment of the present invention; and

FIGS. 4A and 4B are, respectively, a graph showing electrical characteristics of a light emitting diode driving apparatus according to the related art and a graph showing electrical characteristics of a light emitting diode driving apparatus according to the embodiment of the present invention.

### DETAILED DESCRIPTION OF THE EMBODIMENTS

Hereinafter, embodiments will be described in detail with reference to the accompanying drawings so that they can be easily practiced by those skilled in the art to which the present invention pertains.

However, in describing embodiments of the present invention, detailed descriptions of well-known functions or constructions will be omitted so as not to obscure the description of the present invention with unnecessary detail.

In addition, like or similar reference numerals denote parts performing similar functions and actions throughout the drawings.

A case in which any one part is stated as being connected to another part includes a case in which the parts are directly connected to each other and a case in which the parts are indirectly connected to each other with other elements interposed therebetween.

In addition, unless explicitly described otherwise, “comprising” any components will be understood to imply the inclusion of other components but not the exclusion of any other components.

Embodiments of the present invention will now be described in detail with reference to the accompanying drawings.

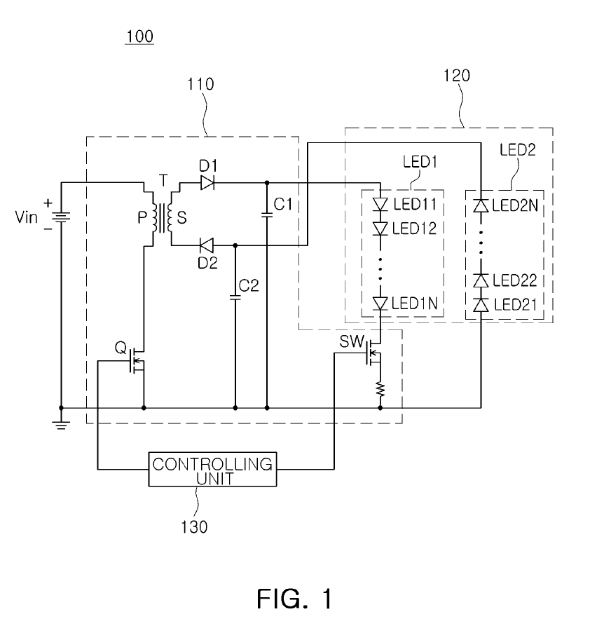

FIG. 1 is a circuit diagram schematically showing a light emitting diode driving apparatus according to an embodiment of the present invention.

Referring to FIG. 1, the light emitting diode driving apparatus 100 according to the embodiment of the present invention may include a power supplying unit 110, a light emitting diode unit 120, and a controlling unit 130.

The power supplying unit 110 may include a power switch Q, a transformer T, and a current control switch SW.

The power switch Q may switch an input power Vin according to a control of the controlling unit 130. The input power Vin may be direct current (DC) power.

The transformer T may include a primary winding P and a secondary winding S, wherein the primary winding P may receive switched power and the secondary winding S may have a preset turns ratio for the primary winding P to transform a voltage level of the switched power, thereby outputting driving power capable of driving a light emitting diode. The secondary winding S may have one end to which driving power having a positive voltage level is output and the other end to which driving power having a negative voltage level is output.

The driving power from one end and the other end of the secondary winding may be transferred to the light emitting diode unit 120, and the current control switch SW may control current flowing in the light emitting diode of the light emitting diode unit 120 according to the control of the controlling unit 130.

The light emitting diode unit 120 may include at least one light emitting diode group which includes a first light emitting diode array LED1 and a second light emitting diode array LED 2.

Respective first and second light emitting diode arrays LED1 and LED2 may include at least one light emitting diode or a plurality of light emitting diodes connected to one another in series.

Respective first and second light emitting diode arrays LED1 and LED2 may include a plurality of light emitting diodes LED11 to LED 1N and LED21 to LED2N, wherein an anode of a first light emitting diode LED11 of the first light emitting diode array LED1 may be electrically connected to one end of the secondary winding S and a cathode of a final light emitting diode LED2N of the second light emitting diode array LED2 may be electrically connected to the other end of the secondary winding S. Here, the anode of the first light emitting diode LED11 of the first light emitting diode LED1 and one end of the secondary winding S may have a diode and a capacitor D1 and C1 connected therebetween as shown in FIG. 1 in order to stabilize the driving power having the positive voltage level. Likewise, the cathode of the final light emitting diode LED2N of the second light emitting diode array LED2 and the other end of the secondary winding S may have a diode and a capacitor D2 and C2 connected therebetween as shown in FIG. 1 in order to stabilize the driving power having the negative voltage level.

The first and second light emitting diode arrays LED1 and LED2 may have the current control switch SW connected therebetween. More specifically, the current control switch SW may be connected between a cathode of a final light emitting diode LED1N of the first light emitting diode array LED1 and an anode of a first light emitting diode LED21 of the second light emitting diode array LED2. In addition, as shown in FIG. 1, a detection resistor may be electrically connected between the current control switch SW and the anode of the first light emitting diode LED21 of the second light emitting diode array LED2 in order to detect current flowing in the light emitting diode array.

Through the circuit connection as described above, the secondary winding S, the diodes D1 and D2, the first and second light emitting diode arrays LED1 and LED2, the current control switch SW, and the detection resistor may form a single loop. Therefore, the first and second light emitting diode arrays LED1 and LED2 may simultaneously perform or stop a light emitting operation according to the current control switch SW being turned-on or turned-off to control an operation of two light emitting diode arrays by a single current control switch SW.

The controlling unit 130 may control current control switch SW and power switch Q switching operations according to information detected from the detection resistor. As described above, the controlling unit 130 may turn the current control switch SW on or off to allow the first and second light emitting diode arrays LED1 and LED2 to simultaneously perform or stop a light emitting operation according to the current control switch SW being turned-on or turned-off, thereby controlling an operation of two light emitting diode arrays by a single current control switch SW.

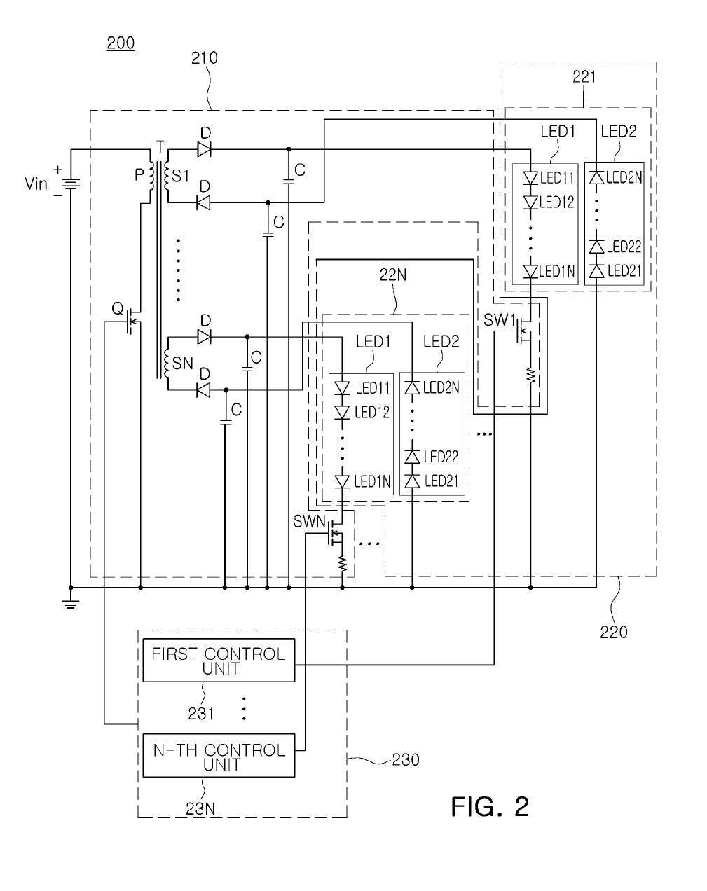

FIG. 2 is a circuit diagram schematically showing a light emitting diode driving apparatus according to another embodiment of the present invention.

Referring to FIGS. 1 and 2, the light emitting diode driving apparatus 200 according to another embodiment of the present invention may be different from the light emitting diode driving apparatus 100 according to the embodiment of the present invention shown in FIG. 1, in that a transformer T of a power supplying unit 210 may include a plurality of secondary windings S1 to SN, a light emitting diode unit 220 may include a plurality of light emitting diode groups 221 to 22N, each connected to the plurality of secondary windings S1 to SN, and the power supplying unit 210 may include a plurality of current control switches SW1 to SWN corresponding to the plurality of light emitting diode groups 221 to 22N. Therefore, a controlling unit 230 may include a plurality of control units 231 to 23N, each controlling the plurality of current control switches SW1 to SWN.

Similar to the light emitting diode driving apparatus 100 according to the embodiment of the present invention shown in FIG. 1, the plurality of secondary windings S1 to SN and the plurality of light emitting diode groups 221 to 22N may have diodes D electrically connected therebetween and capacitors C connected in parallel with each other therebetween.

Respective light emitting diode groups among the plurality of light emitting diode groups 221 to 22N may include first and second light emitting diode arrays LED1 and LED2, and respective first and second light emitting diode arrays LED1 and LED2 of the plurality of light emitting diode groups 221 to 22N may include a plurality of light emitting diodes LED11 to LED1N and LED21 to LED2N.

In respective light emitting diode groups among the plurality of light emitting diode groups 221 to 22N, a process of forming a plurality of loops through an electrical connection between the first and second light emitting diode arrays LED1 and LED2 and the plurality of secondary windings S1 to SN may be the same as that of the process shown in FIG. 1. Therefore, a detailed description thereof will be omitted.

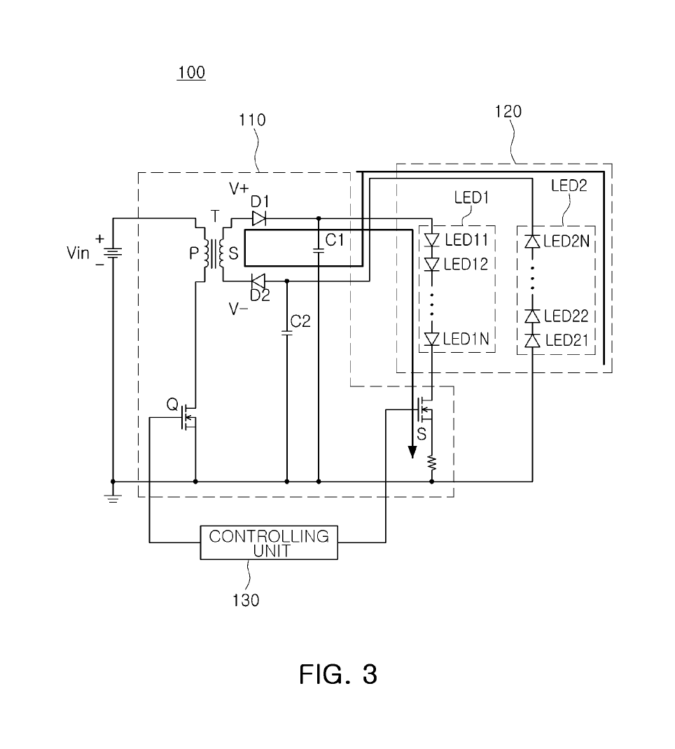

FIG. 3 is a circuit diagram schematically showing a current transfer path of the light emitting diode driving apparatus according to the embodiment of the present invention.

Referring to FIG. 3, as described above, a single electrical loop may be formed between the secondary winding S and the first and second light emitting diode arrays LED1 and LED2 to allow two light emitting diode arrays to perform or stop alight emitting operation with a single current control switch SW.

Although the current transfer path in a single loop formed between the secondary winding S and the first and second light emitting diode arrays LED1 and LED2 in the light emitting diode driving apparatus 100 according to the embodiment of the present invention shown in FIG. 1 is shown in FIG. 3, since current transfer paths in the plurality of loops formed between the plurality of secondary windings S1 to SN and respective light emitting diode arrays among the first and secondary light emitting diode arrays LED1 and LED2 of the plurality of light emitting diode groups 221 to 22N in the light emitting diode driving apparatus 200 according to another embodiment of the present invention shown in FIG. 2 are the same as the current transfer path, a description thereof will be omitted.

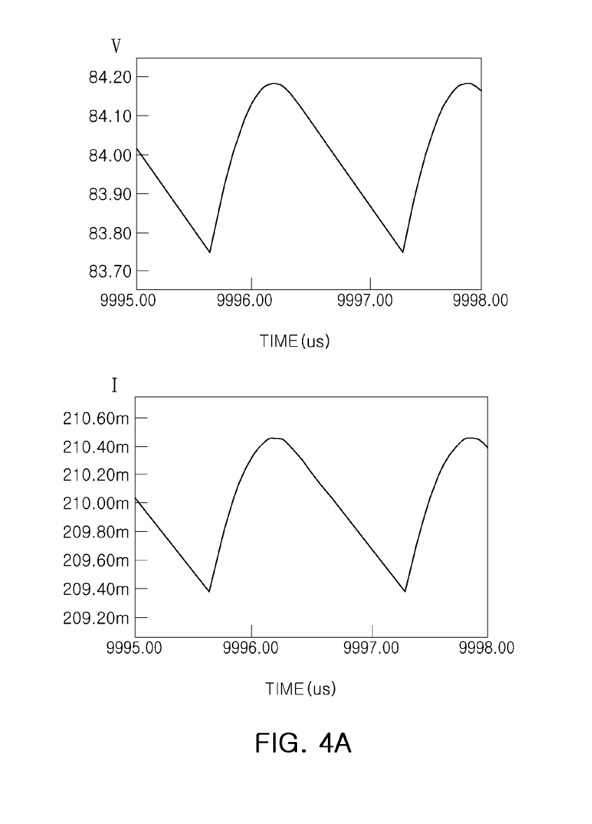

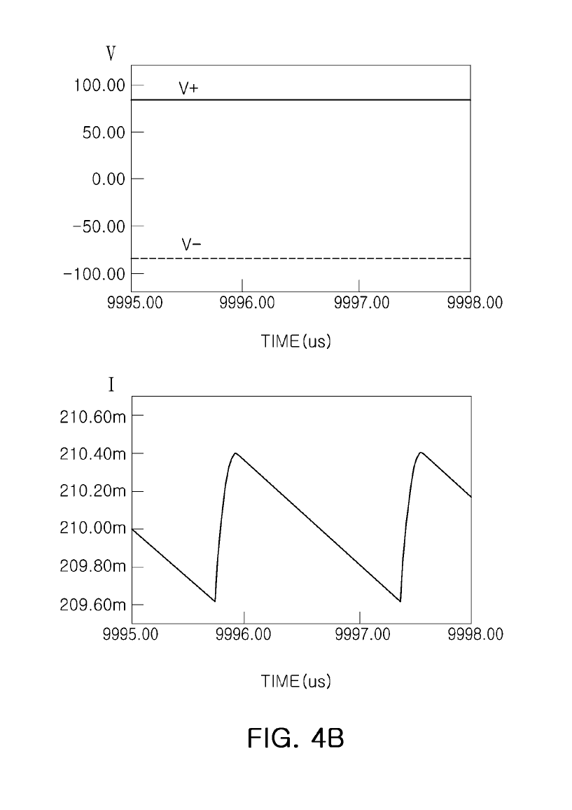

FIGS. 4A and 4B are, respectively, a graph showing electrical characteristics of a light emitting diode driving apparatus according to the related art and a graph showing electrical characteristics of a light emitting diode driving apparatus according to the embodiment of the present invention.

Referring to FIG. 4A, driving power of the light emitting diode driving apparatus according to the related art and current flowing in a light emitting diode array are shown. Referring to FIG. 4B, it could be appreciated that in the light emitting diode driving apparatus according to the embodiment of the present invention, a driving power V+ having a positive voltage level and a driving power −V having a negative voltage level are output from one end and the other end of the secondary winding, and current flowing in a light emitting diode array is the same as current flowing in the light emitting diode array of the light emitting diode driving apparatus, according to the related art.

That is, in the light emitting diode driving apparatus according to the related art, since the plurality of light emitting diode arrays are connected in parallel with one end of the secondary winding of the transformer, current control switches controlling respective light emitting diode arrays and control units controlling the current control switches have been required; however, in the light emitting diode driving apparatus according to the embodiment of the present invention, the same current as that of the light emitting diode driving apparatus according to the related art is supplied, whereas two light emitting diode arrays may be driven by a single current control switch.

As set forth above, according to the embodiments of the present invention, two LED channels are connected to a secondary output of the transformer so as to form a loop to thereby be driven by a single FET, whereby a peripheral circuit may be simplified. In addition, a low cost IC may be used as an IC for controlling the FET, whereby manufacturing costs may be reduced.

While the present invention has been shown and described in connection with the embodiments, it will be apparent to those skilled in the art that modifications and variations can be made without departing from the spirit and scope of the invention as defined by the appended claims.

What is claimed is:

1. A light emitting diode driving apparatus comprising:
a power supplying unit switching input power according to a control and including a transformer transforming the switched power into a preset driving power, to thus supply the driving power;
a light emitting diode unit including at least one light emitting diode group including first and second light emitting diode arrays each having at least one light emitting diode, the first and second light emitting diode arrays being connected to an output terminal of the transformer to form a single loop and receiving the driving power to emit light; and
a controlling unit controlling power switching of the power supplying unit.

2. The light emitting diode driving apparatus of claim 1, wherein the transformer includes a primary winding receiving the switched power and at least one secondary winding having a preset turns ratio for the primary winding, and
the first and second light emitting diode arrays of the at least one light emitting diode group are electrically connected to one end and the other end of the at least one secondary winding, respectively, to form the single loop.

3. The light emitting diode driving apparatus of claim 2, wherein the power supplying unit further includes a current control switch connected between the first and second light emitting diode arrays to control current flowing in the first and second light emitting diode arrays according to the control of the controlling unit.

4. The light emitting diode driving apparatus of claim 3, wherein the respective first and second light emitting diode arrays include a plurality of light emitting diodes connected to one another in series.

5. The light emitting diode driving apparatus of claim 4, wherein the one end of the at least one secondary winding of the transformer has a positive voltage level and the other end thereof has a negative voltage level,
an anode of a first light emitting diode of the plurality of light emitting diodes of the first light emitting diode array is electrically connected to the one end of the at least one secondary winding, and
a cathode of a final light emitting diode of the plurality of light emitting diodes of the second light emitting diode array is electrically connected to the other end of the at least one secondary winding.

6. The light emitting diode driving apparatus of claim 5, wherein the current control switch is electrically connected between a cathode of a final light emitting diode of the plurality of light emitting diodes of the first light emitting diode array and an anode of a first light emitting diode of the plurality of light emitting diodes of the second light emitting diode array.

7. The light emitting diode driving apparatus of claim 1, wherein the power supplying unit further includes a power switch switching the input power according to the control of the controlling unit.

8. The light emitting diode driving apparatus of claim 2, wherein the transformer includes a plurality of secondary windings each having one end with a positive voltage level and the other end with a negative voltage level, and the light emitting diode unit includes a plurality of light emitting diode groups each connected to the plurality of secondary windings.

9. The light emitting diode driving apparatus of claim 8, wherein an anode of a first light emitting diode of a plurality of light emitting diodes of each first light emitting diode array of the plurality of light emitting diode groups is electrically connected to one end of a corresponding secondary winding, and a cathode of a final light emitting diode of a plurality of light emitting diodes of each second light emitting diode array of the plurality of light emitting diode groups is electrically connected to the other end of the corresponding secondary winding.

10. The light emitting diode driving apparatus of claim 9, wherein the power supplying unit further includes a plurality of current control switches each electrically connected between a cathode of a final light emitting diode of the plurality of light emitting diodes of each first light emitting diode array of the plurality of light emitting diode groups and an anode of a first light emitting diode of the plurality of light emitting diodes of each second light emitting diode array thereof.

11. The light emitting diode driving apparatus of claim 10, wherein the controlling unit includes a plurality of control units each controlling the plurality of current control switches.

12. A light emitting diode driving apparatus comprising:
a power supplying unit including a power switch switching input power according to a control, a transformer having a primary winding receiving the switched power and at least one secondary winding having a preset turns ratio for the primary winding, to thus output a preset driving power, and a current control switch controlling current of a light emitting diode to which the driving power is transferred;
a light emitting diode unit including at least one light emitting diode group including first and second light emitting diode arrays each having at least one light emitting diode, the first and second light emitting diode arrays being connected to one end and the other end of the secondary winding, respectively, to form a single loop and receiving the driving power to emit light; and
a controlling unit controlling power switching and current control switching of the power supplying unit.

13. The light emitting diode driving apparatus of claim 12, wherein the respective first and second light emitting diode arrays include a plurality of light emitting diodes connected to one another in series,
the one end of the at least one secondary winding of the transformer outputs driving power having a positive voltage level and the other end thereof outputs driving power having a negative voltage level,
an anode of a first light emitting diode of the plurality of light emitting diodes of the first light emitting diode array is electrically connected to the one end of the at least one secondary winding, and
a cathode of a final light emitting diode of the plurality of light emitting diodes of the second light emitting diode array is electrically connected to the other end of the secondary winding.

14. The light emitting diode driving apparatus of claim 13, wherein the current control switch is electrically connected between a cathode of a final light emitting diode of the plurality of light emitting diodes of the first light emitting diode array and an anode of a first light emitting diode of the plurality of light emitting diodes of the second light emitting diode array.

15. A light emitting diode driving apparatus comprising:
a power supplying unit including a power switch switching input power according to a control, a transformer having a primary winding receiving the switched power and a plurality of secondary windings having a preset turns ratio for the primary winding to output a preset driving power, and a plurality of current control switches controlling current of a light emitting diode to which the driving power from respective windings among the plurality of secondary windings is transferred;
a light emitting diode unit including a plurality of light emitting diode groups including first and second light emitting diode arrays each having at least one light emitting diode, the first and second light emitting diode arrays being connected to one end and the other end of a corresponding secondary winding, respectively, to form a single loop and receiving the driving power to emit light; and
a controlling unit controlling power switching and current control switching of the power supplying unit.

16. The light emitting diode driving apparatus of claim 15, wherein the respective first and second light emitting diode arrays include a plurality of light emitting diodes connected to one another in series,
one end of respective windings among the plurality of secondary windings of the transformer outputs driving power having a positive voltage level and the other end thereof outputs driving power having a negative voltage level,
an anode of a first light emitting diode of the plurality of light emitting diodes of the first light emitting diode array is electrically connected to one end of the corresponding secondary winding, and
a cathode of a final light emitting diode of the plurality of light emitting diodes of the second light emitting diode array is electrically connected to the other end of the corresponding secondary winding.

17. The light emitting diode driving apparatus of claim 16, wherein respective current control switches among the plurality of current control switches are electrically connected between a cathode of a final light emitting diode of the plurality of light emitting diodes of the first light emitting diode array of a corresponding light emitting diode group and an anode of a first light emitting diode of the plurality of light emitting diodes of the second light emitting diode array thereof.

18. The light emitting diode driving apparatus of claim 17, wherein the controlling unit includes a plurality of control units each controlling the plurality of current control switches.
